(19) United States
(12) Patent Application Publication
(10) Pub. No.: US 2012/0173495 A1
(43) Pub. Date: Jul. 5, 2012

(54) Computer Readable Medium, Systems, and Methods of Detecting a Discrepancy in a Chain-of-title of an Asset

(75) Inventors: Tyron Jerrod Stading, Austin, TX (US); Anthony Richard Hagale, Austin, TX (US); Maneesha Joshi, Austin, TX (US)

(73) Assignee: INNOGRAPHY, INC., Austin, TX (US)

(21) Appl. No.: 12/983,169

(22) Filed: Dec. 31, 2010

(51) Int. Cl. G06F 17/30

(52) U.S. Cl. 707/690; 707/E17.009

(57) ABSTRACT

A computer readable medium includes instructions that, when executed by a processing system, cause the processing system to receive data corresponding to an asset from a data source. The data indicates a chain-of-title of the asset. The computer readable medium further includes instructions that, when executed by the processor, cause the processor to process the data to detect a discrepancy in the chain-of-title in response to receiving the data and generate an output in response to detecting a discrepancy in the chain-of-title

### FIELD

The present disclosure is generally related to the computer-aided detection of discrepancies in a chain-of-title of an asset.

### BACKGROUND

Public records exist that indicate ownership and a chain-of-title of various assets. Such assets can include intellectual property assets (issued patents, published patent applications, registered trademarks, copyrights, etc.), financial instruments (secured loans, insurance instruments, other financial documents, etc.), real property, and various other types of tangible and intangible assets.

Conventionally, verification of ownership of such assets typically requires manual inspection of public records. In some instances, recordation errors, data entry errors, or fraudulent recordings may cause the public records to be changed. Where such records are altered through errors or fraud, the asset owner may be unaware that the ownership status has changed. Further, in asset transfers, particularly those involving multiple assets, public records may not be updated correctly or may not be updated at all.

### SUMMARY

In an embodiment, a computer readable medium includes instructions that, when executed by a processing system, cause the processing system to receive data corresponding to an asset from a data source. The data indicates a chain-of-title of the asset. The computer readable medium further includes instructions that, when executed by the processor, cause the processor to process the data to detect a discrepancy in the chain-of-title in response to receiving the data and generate an output in response to detecting a discrepancy in the chain-of-title.

In another embodiment, a method includes receiving data at an input of a computing system, where the data includes a chain-of-title corresponding to an asset. The method further includes automatically detecting a discrepancy in the chain-of-title of the asset in response to receiving the data and generating an output in response to detecting the discrepancy.

In still another embodiment, a system includes an interface adapted to receive data including information corresponding to a chain-of-title of an asset and a processing system configured to receive the data from the interface. The system further includes one or more memory accessible to the processing system and configured to store a plurality of instructions that, when executed by the processing system, cause the processing system to identify a discrepancy in the chain-of-title of the asset in response to receiving the data and to generate at least one output including data related to the discrepancy.

In yet another embodiment, a system includes an interface configurable to couple to a network and adapted to receive discrepancy data corresponding to a discrepancy in a chain-of-title of an asset from a discrepancy detection system. The system further includes a processing system configured to receive the discrepancy data from the interface and one or more memory accessible to the processing system and configured to store subscriber preferences and a plurality of instructions. The plurality of instructions, when executed by the processing system, cause the processing system to retrieve a notification preference of a subscriber associated with the asset from the subscriber preferences in response to receiving the data, generate at least one output including data related to the discrepancy based on the notification preference of the subscriber, and transmit the at least one output to a corresponding at least one device associated with the subscriber.

### BRIEF DESCRIPTION OF THE DRAWINGS

FIG. 1 is a block diagram of an embodiment of a system including a service provider system and including a discrepancy detection system configured to detect a discrepancy in a chain-of-title of an asset.

FIG. 2 is a block diagram of an alternative embodiment of the discrepancy detection system of FIG. 1.

FIG. 3 is a diagram of a representative example of a user interface displaying an ownership record associated with a United States Patent Publication depicting a discrepancy.

FIG. 4 is a flow diagram of an embodiment of a method of detecting a discrepancy in a chain-of-title of an asset.

FIG. 5 is a flow diagram of a second embodiment of a method of detecting a discrepancy in a chain-of-title of an asset.

FIG. 6 is a block diagram of an embodiment of the service provider system of FIG. 1 that is configurable to communicate with a discrepancy detection system to provide one or more services to a subscriber that are related to asset ownership.

FIG. 7 is a flow diagram of an embodiment of a method of providing an alerting service using the service provider system of FIGS. 1 and 6.

FIG. 8 is a block diagram of a representative example of a system including a user device with which a user may interact to detect a discrepancy related to a chain-of-title of an asset.

In the following description, the use of the same reference numerals in different drawings indicates similar or identical items.

### DETAILED DESCRIPTION OF ILLUSTRATIVE EMBODIMENTS

Embodiments of systems, methods and storage media are described below that provide a means for detecting deficiencies in ownership data associated with an asset. As used herein, the term “asset” refers to anything of material value or usefulness (whether tangible or intangible) that is owned by a person or entity (such as a company or organization). Examples of assets can include, but are not limited to, patents, pending patent applications, trademarks, copyrights, financial instruments, licenses, judgments, and real property (such as a home, an automobile, etc.). In an example, a discrepancy detection system retrieves ownership data for a particular asset from a data source and processes the ownership data to identify breaks in the chain-of-title or other deficiencies. Discrepancy detection system generates an output including data related to the detected discrepancy. In some instances, the output may be an output signal, such as an alert, an electronic message, or another communication signal. In other instances, the output may be printed document configured with the data. Further, discrepancy detection system can operate as a back-end for a service provider system.

In an example, a service provider system can be configured to communicate with the discrepancy detection system to communicate asset data and to receive discrepancy data indicating discrepancies within the chains-of-title of assets within the asset data. In this instance, service provider system can be configured by a subscriber to monitor one or more assets associated with a subscriber. The service provider system can communicate with the discrepancy detection system to monitor the ownership status of the assets and can communicate discrepancies to a subscriber device when a discrepancy is detected. In a particular instance, service provider system can be configured to automatically initiate correction of discrepancies in a chain-of-title of a particular asset, such as by generating an electronic document populated with data related to the discrepancy, which electronic document can be communicated to an agency that records conveyances of assets to correct the discrepancy.

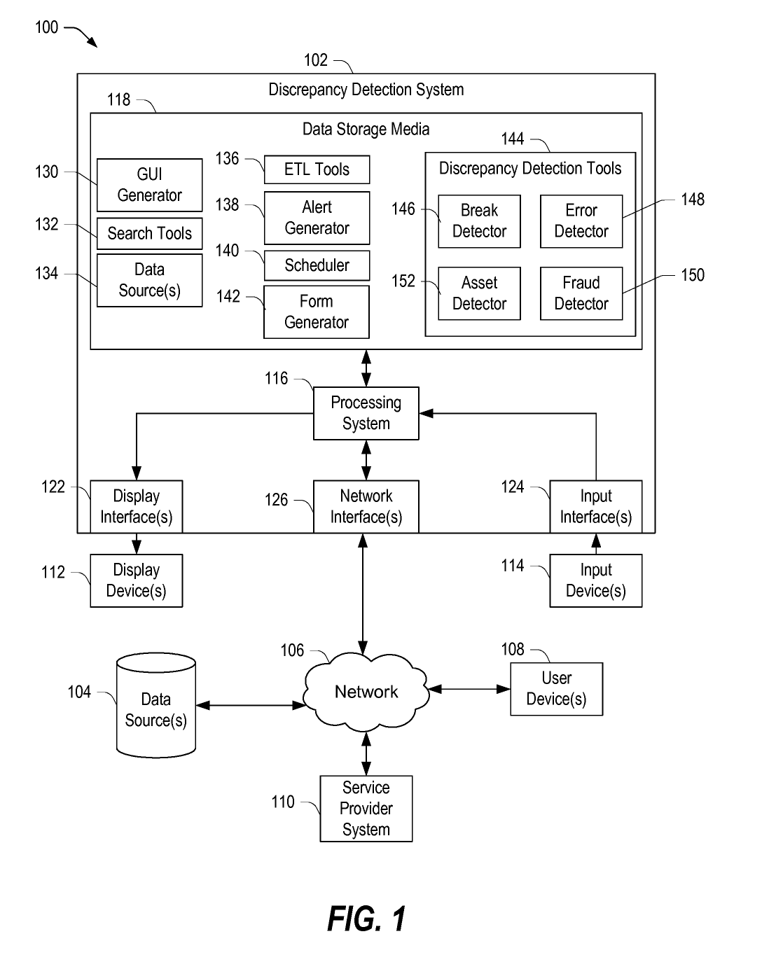

FIG. 1 is a block diagram of an embodiment of a system 100 including a service provider system 110 and including a discrepancy detection system 102 configured to detect a discrepancy in a chain-of-title of an asset. Discrepancy detection system 102 can communicate with service provider system 110, a user device 108, and a data source 104 through network 106. Network 106 may be a local area network, a wide-area network (such as the Internet), a public-switched telephone network, a radio frequency network, or any combination thereof. It should be appreciated that user device 108 and data source 104, though depicted as a single entity, could include multiple user devices 108 and multiple data sources 104.

Discrepancy detection system 102 includes a display interface 122 configured to connect to a display device 112 for providing display information. Further, discrepancy detection system 102 includes an input interface 124 configured to receive user input and/or input data from an input device 114, such as a keyboard, a pointer, a mouse, a Universal Serial Bus (USB) device, a scanner, or other user-accessible devices. In some embodiments, multiple display interfaces 122 and multiple input interfaces 124 can be provided. Discrepancy detection system 102 further includes a processing system 116 connected to display interface 122 and to input interface 124. As used herein, the term “processing system” or “processor” refers to one or more processors capable of executing processor-readable instructions and located within a single computing device or distributed across multiple computing devices. The term “computing device” or “computing system” refers to any electronic device having a processor and memory and that is configurable to execute processor-readable instructions to perform an operation. Processing system 116 is configured to communicate with network 106 through a network interface 126. In some implementations, multiple network interfaces 126 may be included, such as a multiple network interfaces to a common network for improved data throughput or multiple network interfaces to different networks to facilitate communication through different types of networks, for example.

Processing system 116 is also connected to memory 118. As used herein, the term “memory” refers to one or more data storage media, which can be included within a single hard drive or which can be distributed across multiple hard drives and/or multiple computing systems. In an example, memory 118 includes a storage area network that is distributed across a plurality of computing systems.

Memory 118 stores data and processor-executable instructions. For example, memory 118 includes graphical user interface (GUI) generator instructions 130 that are executable by processing system 116 to produce a user interface including multiple user-selectable elements and including at least one of text and an image. In some instances, processing system 116 executes GUI generator instructions 130 to produce a user interface that can be rendered within an Internet browser application, including at least one of a text input field, a pull-down menu, a check box, a user-selectable link, text, or an image.

Memory 118 also stores one or more search tools 132 executable by processing system 116 to retrieve information from data source 104 and from local data source 134. Memory 118 further includes extract-transform-load (ETL) tools 136 executable by processing system 116 to extract data from retrieved information, to transform the data into a normalized format, and to load the data for further processing. Memory 118 also includes discrepancy detection tools 144 executable by processing system 116 to process the loaded data to detect discrepancies in a chain-of-title associated with the data.

Discrepancy detection tools 144 include a break detector 146 executable by processing system 116 to analyze the transferor (assignor) data and the transferee (assignee) data within a chain-of-title of an asset to detect a break or error in the chain-of-title. Processing system 116 may execute error detector instructions 148 and fraud detector instructions 150 to determine whether a break in the chain-of-title is likely to be attributable to an error or to a fraudulent act, respectively. Discrepancy detection tools 144 further include asset detector instructions 152, which is executable by processing system 116 to identify a possible second asset for which a particular conveyance was intended. For example, a recordation of assignment for a particular asset may be incorrectly recorded with respect to a second asset by transposing a number, such as a patent application number. Processing system 116 executes asset detector instructions 152 to identify the asset to which the incorrect recording belongs.

Memory 118 also includes an alert generator 138 executable by processing system 116 to generate an output in response to detecting a discrepancy. Memory 118 further includes a scheduler 140 executable by processing system 116 to control when to retrieve and process asset ownership information. Memory 118 also includes a form generator 142 that is executable by processing system 116 to generate one or more forms populated with data associated with the discrepancy to facilitate and/or initiate correction of the discrepancy.

In an example, discrepancy detection system 102 receives data that uniquely identifies an asset, such as a patent number. Discrepancy detection system 102 may receive the data from user device 106, from service provider server 110, or from scheduler 140 (based on a pre-configured monitoring schedule). Discrepancy detection system 102 uses search tools 132 to query one or more data sources, such as local data source 134 and/or data source 104 for ownership data associated with the asset. In one instance, data source 104 can be a publicly accessible database, such as the assignment databases accessible through the website of the United States Patent and Trademark Office. Alternatively, data source 104 can include one or more private data sources as well, such as enterprise records, bank records, or other types of private data sources. In response to searching data source 134 and data source 104, discrepancy detection system 102 receives search results.

Upon receiving the search results from queries, discrepancy detection system 102 uses ETL tools 136 to extract, transform, and load the ownership data from the results. Discrepancy detection system 102 then uses discrepancy detection tools 144 to process the ownership data to detect a discrepancy. If no discrepancy is found, discrepancy detection system 102 uses alert generator 138 to notify a requesting device, such as user device 106, service provider server 110, or scheduler 140 that no discrepancy was found. Alternatively, if a discrepancy is detected, discrepancy detection system 102 uses alert generator 138 to produce an output signal (such as an email, a text message, a phone call, or another alert) and to send the output signal to the requesting device. In an embodiment, the output signal includes at least a portion of the data associated with the discrepancy.

A discrepancy is any logical inconsistency in the chain-of-title data for a particular asset. Such errors can include misspelled transferee or transferor information, breaks in the chain-of-title from transferee to a second transferor, multiple transfers from a single transferee to different transferors and so on. Discrepancy detection system 102 can use discrepancy detection tools 144 to detect such discrepancies in a variety of ways.

In one example, discrepancy detection system 102 compares a known “good” chain-of-title from local data source 134 to chain-of-title data retrieved from data source 104. In this instance, discrepancy detection system 102 flags any inconsistency as a discrepancy. In another example, discrepancy detection system 102 verifies a consistent chain of title from a first transferor to a first transferee, from the first transferee to a second transferee, and so on. In this example, discrepancy detection system 102 flags different spellings of the transferee's name and/or a break in the link from transferee to transferee as a discrepancy. Discrepancy detection system 102 may also utilize other information, such as subsidiary information, mergers and acquisition information, marriage/divorce data, etc., to check for consistencies. Further, discrepancy detections system 102 applies normalization and spell-check functions to the records to account for typographical errors that might otherwise result in false positives. In yet another example, discrepancy detection system 102 detects when a transferee attempts to transfer the asset to multiple different entities as a possible fraud. In one particular example, discrepancy detection system 102 checks for “suspicious” transactions, such as transfers from the corporate entity back to an inventor, transfers of a portion, but not all, of a family of assets, or changes to correspondence addresses to verify consistency and/or to detect possible fraud.

In an example, discrepancy detection system 102 performs a chain-of-title verification process upon request or in response to a trigger from scheduler 140. In one particular example, discrepancy detection system 102 examines the data for discrepancies periodically. In another example, after an initial verification, any subsequent change in the ownership status may be flagged as a discrepancy requiring further review.

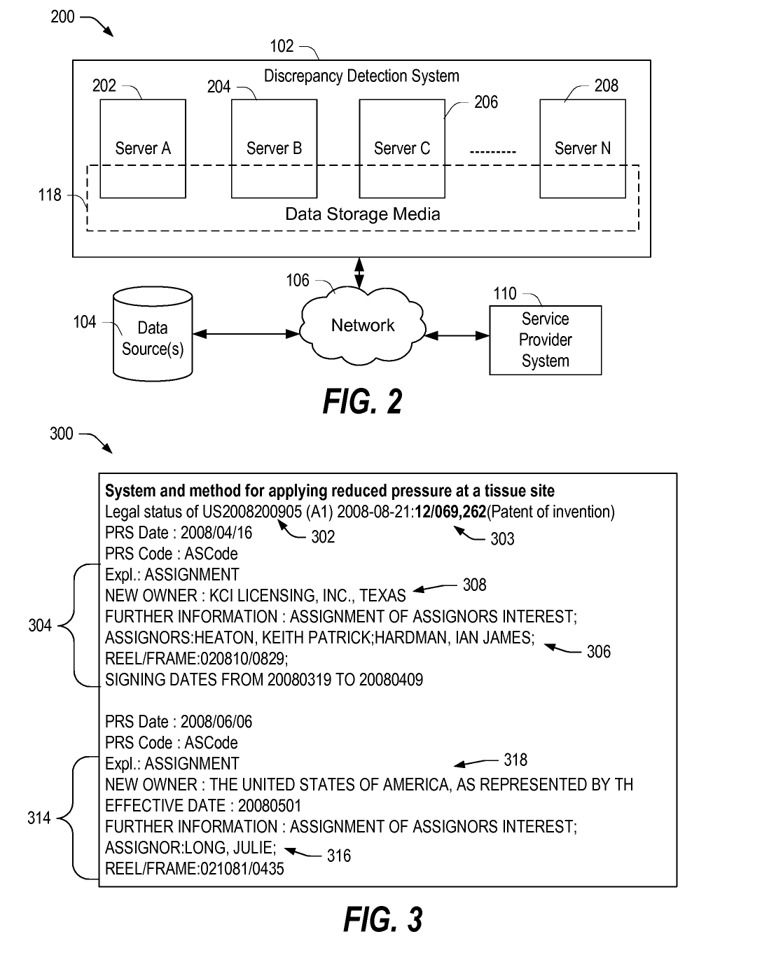

While discrepancy detection system 102 is depicted as being a single computing device, it should be understood that discrepancy detection system 102 can be implemented as a system including multiple servers and a distributed memory. An example of such a distributed system is described below with respect to FIG. 2.

FIG. 2 is a block diagram of an alternative embodiment of the discrepancy detection system 102 of FIG. 1. In this alternative embodiment 200, discrepancy detection system includes multiple computing systems implemented as servers, including a first server 202, a second server 204, a third server 206, and a fourth server 208. Each server 202, 204, 206, and 208 is configured to implement one or more applications or services. Further, memory 118 is distributed across servers 202, 204, 206, and 208, including the various instructions and local data storage.

In an example, alternative embodiment 200 of discrepancy detection system 102 is configurable to perform the same operations described above with respect to FIG. 1. However, various operations and processes may be shared between servers 202, 204, 206, and 208. In an alternative embodiment, particular servers may be configured to perform particular dedicated functions. For example, first server 202 may provide user interface and alert generation functions, while second server 204 operates one or more of discrepancy detection tools 144.

FIG. 3 is a diagram of a representative example of a user interface 300 displaying an ownership record associated with a United States Patent Publication depicting a discrepancy for an asset 302, which is identified as U.S. Published Patent Application No. 2008/200905(A1). User interface 300 includes a first assignment recordation 304 recorded at REEL 020810 and FRAME 0829 and listing transferors (assignors) 306 and transferees (assignees) 308. In this instance, the assignors 306 are Keith Patrick Heaton and Ian James Hardman and the assignee 308 is KCI Licensing, Inc. User interface 300 also shows a second assignment recordation 314 recorded at REEL 021081 and FRAME 0435 and listing assignors 316 (Julie Long) and assignees 318 (The United States of America).

In the context of intellectual property assets, such as patent applications/issued patents, it is assumed that most intellectual property assets are assigned to (or intended to be assigned to) a single entity, if an assignment is executed at all. However, in some instances, an intellectual property asset may be jointly owned by two entities. Discrepancy detection system 102 can disambiguate some multi-assignment issues by comparing, for example, inventor names associated with the asset to the transferee names to verify that each of the original assignees had an assignable interest in the asset. Thus, if the original inventors are responsible for two different assignments from one set of inventors to one entity and from another set of inventors to another entity, discrepancy detection system 102 may initially flag the chain-of-title as having a discrepancy. However, a user may over-ride the flag by interacting with the user interface to indicate that the chain-of-title information is correct. In this instance, discrepancy detection system 102 may store the chain-of-title information (and or an indicator that the multiple assignments are correct) in local data source 134 so that discrepancy detection system 102 won't identify that particular chain as having a discrepancy in the future. In particular, discrepancy detection system 102 may subsequently compare the chain-of-title information from local data source 134 to chain-of-title information retrieved from data source 104 to detect discrepancies.

In an example, discrepancy detection system 102 executes discrepancy detection tools 144 to detect a discrepancy in the chain-of-title for asset 302. By tracing the chain from assignor to assignee, a break in the chain-of-title is detected between the assignor 308 and the assignee 316. Discrepancy detection system 102 may retrieve information about asset 302 from another data source, such as data source 134 or data source 104, for example to determine inventor names, in order to determine which of the assignment recordations 304 or 314 is erroneous.

In this example, processing system 116 executes break detector 146 to detect the discrepancy (break) in the chain-of-title of asset 302. In this instance, the assignor “Julie Long” is not an inventor and is not the previous transferee. Accordingly, there is a break in the chain-of-title between the two recordations of assignment 304 and 314.

Processing system 116 executes error detector instructions 146 to determine which of the recordations 304 and 314 is erroneous, such as by determining which of the transferees is correctly associated with asset 302 (in this instance, recordation 304). Processing system 116 executes asset detection instructions 152 to identify a second asset to which recordation 314 should apply. In this instance, processing system 116 executes asset detection instructions 152 to identify the second asset as being U.S. Patent Publication No. 2008/0199846. In particular, asset detection instructions 152, when executed, cause processing system 116 to search one or more data sources for assignor 316 and to search on variations of application serial number 303 (Ser. No. 12/069,262). In this instance, only one application was identified that listed the assignor 316. That particular application had an application serial number (Ser. No. 12/069,292) that differed from that of asset 302 by one digit, the second-to-last digit, which is a nine, rather than a six as in asset 302. In this instance, the second recordation 314 may have been recorded over the first recordation 304, producing the discrepancy, due to a typographical error.

In an example, the capacity to detect the second asset makes it possible to produce an alert that can notify an intended owner of the second asset so that the second owner can correct his/her ownership information for the second asset. Further, this capacity can be used by a service provider system to identify possible new subscribers and/or to serve notice on the intended owners of such assets.

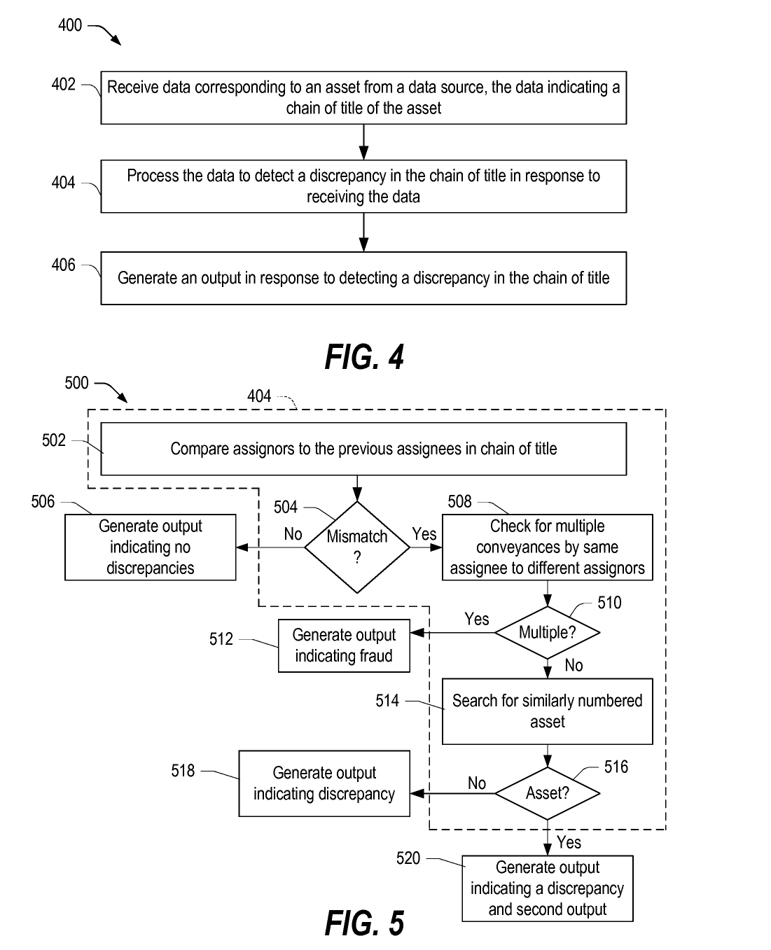

While the above-discussion of FIGS. 1-3 have focused on the systems configured to detect discrepancies in a chain-of-title, the detection process itself can take any number of forms. A simple example of a method of detecting a discrepancy in a chain-of-title of an asset, such as asset 302 in FIG. 3, is described below with respect to FIG. 4.

FIG. 4 is a flow diagram of an embodiment of a method 400 of detecting a discrepancy in a chain-of-title of an asset. At 402, data corresponding to an asset is received from a data source, where the data indicates a chain-of-title of the asset. In one instance, the data may be received in response to a query generated by discrepancy detection system 102 or by another computing system. In another instance, the data may be provided by a third party or a user device.

Advancing to 404, the discrepancy detection system 102 processes the data to detect a discrepancy in the chain-of-title in response to receiving the data. As discussed above, the discrepancy can be detected based on a break in the chain-of-title, based on multiple assignments by an inventor, based on an indicator provided by a third party, or any combination thereof. One such indicator by a third party may be an affidavit that a particular assignment is fraudulent, such as a forged signature.

Moving to 406, discrepancy detection system 102 generates an output in response to detecting the discrepancy in the chain-of-title. The output may be an email alert, a phone call, a text message, an electronic report, a physical report, or some other output. In an example, the output may be provided to a merge tool or report generator for automatic population of a document for notifying an asset owner, for correcting the discrepancy, or both. In another instance, the output may be a signal that is sent to a service provider system 110 for use in generating reports and or in taking remediation steps.

FIG. 5 is a flow diagram of a second embodiment of a method 500 of detecting a discrepancy in a chain-of-title of an asset. Method 500 includes a more detailed explanation of one possible way of processing the data to detect a discrepancy as identified at 404 in FIG. 4. Method 500 begins after the data related to the chain-of-title of an asset has already been received.

At 502, assignors are compared to previous assignees in the chain-of-title. Advancing to 504, if there is no mismatch, the method 500 proceeds to 506, and discrepancy detection system 102 generates an output indicating no discrepancies. Otherwise, at 504, if there is a mismatch, the method 500 proceeds to 508, and discrepancy detection system 102 checks for multiple conveyances by the same assignee to different assignors.

Continuing to 510, if there are multiple conveyances, the method 500 advances to 512 and discrepancy detection system 102 generates an output indicating that the discrepancy may be the result of a fraud. Returning to 510, if there are no multiple conveyances from the same assignee to different assignors, the method 500 proceeds to 514 and discrepancy detection system 102 uses asset detection instructions 152 to search for a similarly numbered asset (e.g., in a patent context, a similar publication number, a similar patent number, a similar application number, etc.) In a different context, the similarly numbered asset may be a loan number, a document identifier, or some other number or character string.

Moving to 516, if no similarly numbered (or character string) asset is identified, the method 500 advances to 518 and discrepancy detection system 102 generates an output indicating the discrepancy. The output includes data related to the discrepancy. At 516, if a similarly numbered (or character string) asset is identified, the method 500 proceeds to 520 and discrepancy detection system 102 generates an output indicating the discrepancy and generates a second output. In one instance, the second output is a notice letter or signal that can be transmitted to the intended owner of a second asset, notifying the intended owner of the incorrect recordation.

In the methods described above with respect to FIGS. 4 and 5, it should be appreciated that the particular flow diagrams are provided for illustrative purposes only, and that the particular operations may be performed in different orders and/or some may be omitted or other operations added without departing from the scope of the disclosure. In an alternative embodiment, after receiving chain-of-title information for an asset, discrepancy detection system 102 may retrieve chain-of-title information from local data source 134 and compare them to determine whether any changes have been recorded with respect to information stored by data source 104. If no changes have been made, it can be determined that there is no discrepancy.

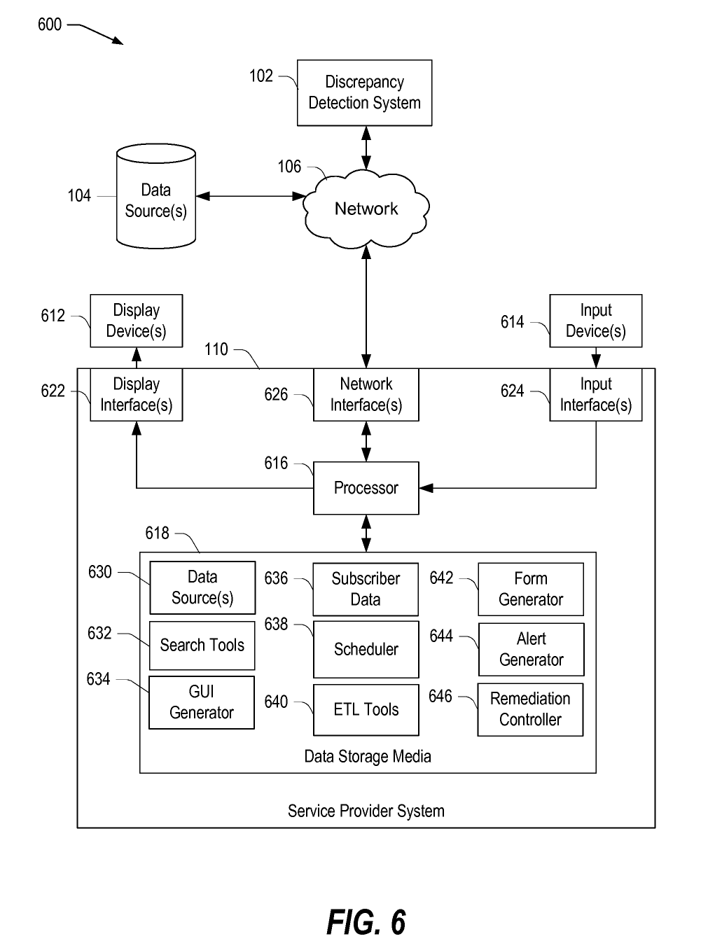

FIG. 6 is a block diagram of an embodiment 600 of the service provider system 110 of FIG. 1 that is configurable to communicate with discrepancy detection system 102 to provide one or more services to a subscriber that are related to asset ownership. For example, service provider system 110 may provide a monitoring service, an asset ownership recordation correction service, a fraud alert service, and so on, relying on discrepancy detection system 102 as a back-end to identify possible discrepancies in the chain-of-title of particular assets.

Service provider system 110 includes a processor 616 connected to a network interface 626, which is communicatively coupled to discrepancy detection system 102 and one or more data sources 104 through network 106. Further, processor 616 is connected to one or more input interfaces 624, which are connected to one or more input devices 614 for receiving user input. Additionally, processor 616 is connected to one or more display interfaces 622, which are connected to one or more display devices 612. Service provider system 110 includes a memory 618 connected to processor 616 and configured to store instructions executable by processor 616 to provide a service, such as an asset monitoring service, an asset ownership correction service, or another service based on detection of discrepancies in a chain-of-title of an asset.

Memory 618 includes one or more data sources 630, search tools 632, and a GUI generator 634. Search tools 632 are executable by processor 616 to query data sources 630, data sources 104, and optionally other data sources. GUI generator 634 generates a graphical user interface through which an operator can configure the service provider system 110, such as by creating subscribers, updating subscriber data 636, and interacting with form generator 642, scheduler 638, and remediation controller 646 to configure service provider system 110 for operation in response to receiving a signal indicating a discrepancy in a chain-of-title from discrepancy detection system 102.

Form generator 642, when executed by processor 616, causes processor 616 to generate forms, such as form documents for communicating discrepancies to third-parties or for correcting discrepancies with a recordation authority. Processor 616 executes ETL tools 640 to extract, transform, and load data received from discrepancy detection system 102, which loaded data can be used to populate forms. Processor 616 also executes alert generator 644 to generate alerts. The alerts can be emails, text messages, telephone calls, or other signals. In an embodiment, processor 616 accesses the subscriber data 636 to determine the subscriber's alerting preferences, and executes alert generator 644 to generate alerts according to the subscriber's preferences. Remediation controller 646, when executed, controls the subsequent actions taken by service provider system 110 based on the subscriber preferences and based on the type of discrepancy identified. For example, an erroneous recordation may be corrected using a first form, whereas a fraudulent recordation may require multiple documents and different actions involving multiple people and entities. In some instances, it may require filing of documents in a court of law.

In an example, a user accesses a user interface provided by service provider system 110 to configure subscriber settings, including identifying assets to be verified and monitored. The assets may be manually entered or imported from a document (such as a spreadsheet). Once entered, service provider system 110 uses search tools 632 to trigger discrepancy detection system 102 to process ownership data for the assets. In one instance, service provider system 110 retrieves the ownership data from one or more data sources 104 and provides the ownership data to discrepancy detection system 102. In another instance, service provider system 110 provides one or more asset identifiers to discrepancy detection system 102 and waits for the results.

Discrepancy detection system 102 processes the ownership data (after receiving the ownership data from service provider system 110 or from one or more data sources 104 in response to a query generated by discrepancy detection system 102. Discrepancy detection system 102 sends one or more signals to service provider system 110 indicating the results of the processing. If a discrepancy is detected, the one or more signals include data related to the discrepancy.

In response to receiving the one or more signals from discrepancy detection system 102, service provider system 110 generates a user interface including the discrepancy information for review by an operator of the subscriber. In some instances, as described above with respect to the multiple assignments where the multiple assignments are proper, a flagged discrepancy may be correct. The operator may interact with the user interface to verify whether particular discrepancies should be marked as correct, reported to a subscriber, etc. Once the data is selected for reporting to the subscriber (or alternatively in response to receiving the discrepancy data), service provider system 110 uses ETL tools 640 to extract, transform, and load data from the one or more signals and uses alert generator instructions 644, subscriber data 636, form generator 642, and remediation controller 646 to process the discrepancy data and to produce a desired output according to the subscriber's preferences.

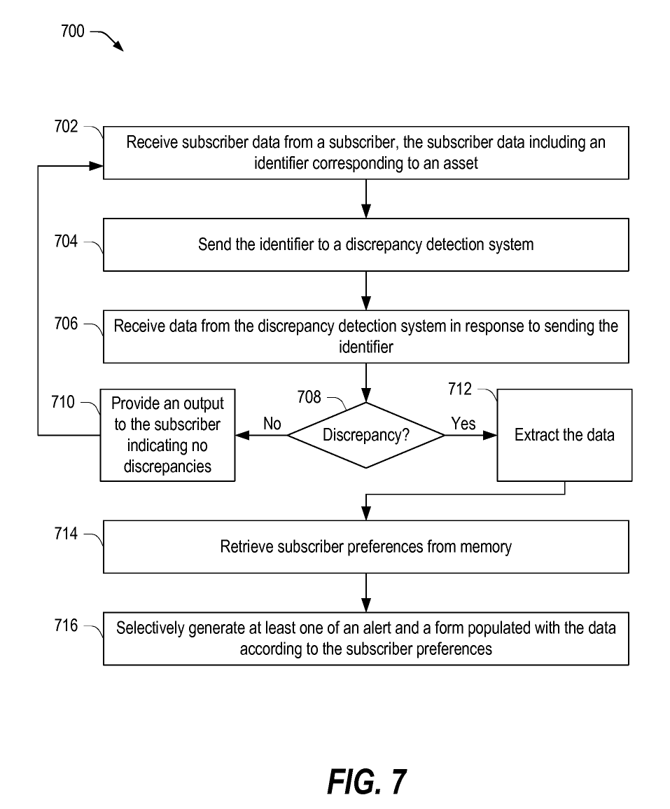

Service provider system 110 can process individual assets or logically clustered assets, such as commonly owned assets, allowing any individual or any type of entity to become a subscriber for the purpose of monitoring ownership information related to their assets. Scheduler 638 causes service provider system 110 to check the ownership information periodically (such as weekly, daily, monthly, or at a user-defined interval). In an example, each subscriber can specify its own scheduling preferences and alert preferences, which configuration data is stored in subscriber data 636. An example of one possible embodiment of a method of providing a service using the service provider system 110 is described below with respect to FIG. 7.

FIG. 7 is a flow diagram of an embodiment of a method 700 of providing an alerting service using the service provider system 110 of FIGS. 1 and 6. At 702, service provider system 110 receives subscriber data from a subscriber, where the subscriber data includes an identifier corresponding to an asset. The subscriber data can include a single asset identifier or a large number of asset identifiers corresponding to multiple assets. Advancing to 704, service provider system 110 sends at least one identifier to the discrepancy detection system 102. Moving to 706, service provider system 110 receives data from the discrepancy detection system 102 in response to sending the identifier.

At 708, if the data from the discrepancy detection system 102 indicates there is no discrepancy in the chain-of-title of the asset associated with the identifier, the method advances to 710, the service provider system 110 provides an output to the subscriber indicating no discrepancies. In an embodiment, the query, the results, and the determination that there is no discrepancy can be logged in a data file. The method 700 then waits for a new scheduled event to check again and/or returns to 702 to receive other subscriber data.

At 708, if a discrepancy is indicated, the method proceeds to 712 and the data related to the discrepancy is extracted, either from the signal itself or based on the signal. Proceeding to 714, service provider system 110 retrieves subscriber preferences from memory (such as from subscriber data 636). Continuing to 716, service provider system 110 selectively generates at least one of an alert and a form populated with the data according to the subscriber preferences.

The method 700 represents one possible method for providing subscriber services; however, other methods are also possible. For example, service provider system 110 may be configured to receive an email from a sender that includes a list of asset identifier in the subject header of the email. In this instance, service provider system 110 can parse the email to retrieve the list of assets, communicate with discrepancy detection system 102 based on the list of assets, and transmit a report for each asset to the sender.

In another example, the service provider system 110 may be included as a module within discrepancy detection system 102. In the alternative embodiment of FIG. 2, for example, the service provider system 110 may be an application or service executed on a processor of one of servers 202, 204, 206, and 208.

While the above-examples have largely focused on patent and/or patent publication assignment discrepancies, discrepancy detection system 102 and/or service provider system 110 can be used to detect discrepancies in the chain-of-title of any asset, provided that the data corresponding to the chain-of-title of such assets is available in a computer-retrievable form. If the data exists only in paper documents stored in a file management facility, such data require conversion to a digital form for processing.

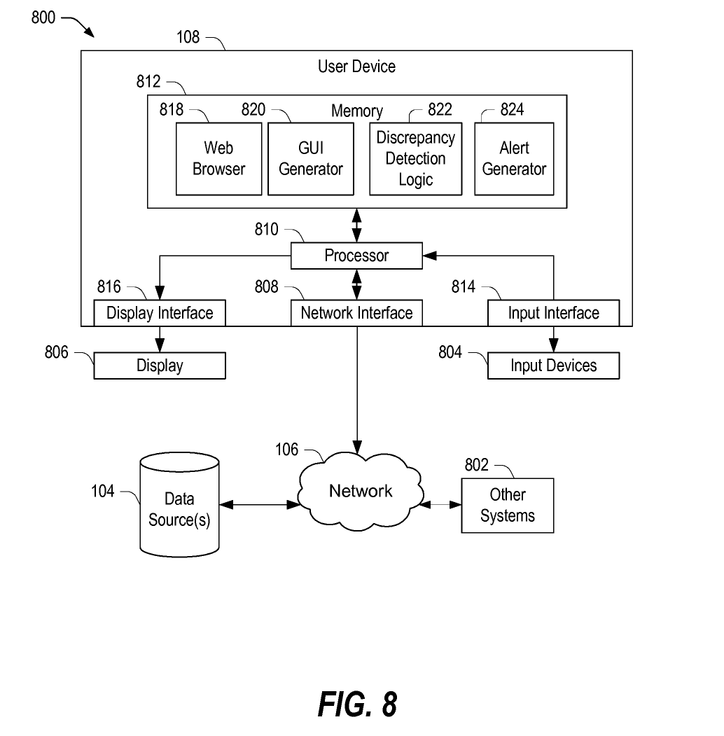

FIG. 8 is a block diagram of a representative example of a system 800 including a user device 108 with which a user may interact to detect a discrepancy related to a chain-of-title of an asset. System 800 further includes data sources 104 and other systems 802 communicatively coupled to user device 108 through network 106. User device 108 is connected to one or more input devices 804 and to a display 806.

User device 108 includes a network interface 808, which is connected to network 106 and to a processor 810. User device 108 further includes a memory 812 connected to processor 810, an input interface 814 connected to input device 804 and to processor 810, and a display interface 816 connected to display 806 and to processor 810.

Memory 812 stores a plurality of instructions accessible to processor 810 to control operation of user device 108. In an example, memory 812 stores an operating system and a variety of applications that execute within the operating system to perform a variety of operations. Memory 812 includes a browser application 818 that is executable by processor 810 to access network 106 and to visit one or more uniform resource locations to view websites. Further, memory 812 includes a graphical user interface (GUI) generator 820 that is executable by processor 822 to produce a GUI including one or more user-selectable elements through which a user can enter information regarding an inventor name, a company name, a list of assets, or some other information that can be used to identify assets to be investigated. Further, GUI generator 820 may provide information relating to results of an investigation into the chain-of-title of one or more assets.

Memory 812 also includes discrepancy detection logic 822, which can be executed by processor 810 to detect a discrepancy in a chain-of-title of a particular asset. In an example, discrepancy detection logic 822 can be a script or a set of instructions that execute within another application, such as within web browser 818, to evaluate the chain-of-title of one or more assets to detect a discrepancy, as previously discussed. Memory 812 further includes alert generator instructions 824, which can be executed by processor 810 to generate an alert or other notification. The generated alert or other notification can include information regarding a detected discrepancy and/or information indicating that no discrepancy was found. GUI generator 820 can provide the alert within a GUI that includes one or more options accessible by the user to define further actions to be taken in response to the alert. Such options can include a “fix it” option that, when selected by the user, causes the user device to take remediation actions to fix the discrepancy. Remediation actions can include populating an electronic form and providing the form to a user for signature and/or automatic generation of forms for submission to a recordation authority to initiate correction of the discrepancy.

In an example, user device 108 is a computing system that can be used to detect discrepancies in a chain-of-title of an asset. Processor 810 produces a graphical user interface including an input for receiving investigative information from a user to define an investigation. The investigative information includes at least one of a name of a company, a name of an individual, a list of asset identifiers or other information suitable for identifying one or more assets to be investigated. The graphical user interface further includes an alert in response to receiving the investigative information. The user device 108 includes an output (e.g., display interface 816) coupled to the processor 810 for providing the alert to the user. In an embodiment, the output may be an input/output interface coupled to a printer or a speaker. In another example, the output may be the network interface 808, and the alert may be an email or text message, a Voice over Internet Protocol (VoIP) telephone call, or some other alerting mechanism for communicating the results of the investigation to a user.

In a particular example, the output includes display interface 816 and display 806, and the alert includes at least one of text information and graphical information related to the investigation. In another example, the output is a signal sent to at least one of a cell phone and a computer. In a particular example, the alert indicates data related to a discrepancy in a chain-of-title of at least one asset associated with one of the company, the individual, and the list of asset identifiers.

The GUI generated using GUI generator 820 includes an identifier related to one or more assets that have an associated discrepancy in the chain-of-title. The GUI further includes at least one user-selectable option for resolving the associated discrepancy associated with at least one of the one or more assets. The user-selectable option includes a first option to fix the associated discrepancy and a second option to ignore the associated discrepancy. Other options may also be available, such as an option to communicate the discrepancy to a third-party.

It should be appreciated that, in some instances, the discrepancy detection logic 822 may include a combination of scripts embedded within web pages and scripts or applications running on a server, such as other systems 802. Further, user device 108 may conduct a search of data sources 104 to retrieve the chain-of-title information and execute such scripts to detect discrepancies in the chains-of-title. Further, data sources 104 may include marriage/divorce information, mergers and acquisition information, and other information that may be useful in resolving discrepancies. In some instances, an alert may include information indicating that further action is needed by a particular company to perfect the chain-of-title, such as after a merger or during an asset purchase event.

In some instances, all of the actions may be performed by user device 108 by executing software stored locally or downloaded from a server. In this instance, data may be retrieved from local or remote data sources and may be processed to detect discrepancies and to produce alerts. Such alerts may range from an acknowledgement that the data was retrieved and processed and that no discrepancies were found to a list of assets having discrepancies in their respective chains-of-title. When discrepancies are found, the GUI may include user-selectable options allowing the user to control what actions are to be taken. Alternatively, the system may automatically perform remediation actions, without requesting further input from the user.

In conjunction with the systems, methods, and computer-readable media discussed above with respect to FIGS. 1-7, a system is disclosed that processes asset ownership information to detect discrepancies in a chain-of-title of the asset. The system produces an output that includes data related to the discrepancy is a discrepancy is detected. In some instances, the system operates in conjunction with a service provider system to provide a monitoring service for monitoring the ownership status of the assets.

Although the present invention has been described with reference to preferred embodiments, workers skilled in the art will recognize that changes may be made in form and detail without departing from the scope of the invention.

1. A computer readable storage medium comprises instructions that, when executed by a processing system, cause the processing system to:
receive data corresponding to an asset from a data source, the data indicating a chain-of-title of the asset;
process the data to detect a discrepancy in the chain-of-title in response to receiving the data; and
generate an output in response to detecting a discrepancy in the chain-of-title.

2. The computer readable storage medium of claim 1, wherein the instructions that, when executed by the processing system, cause the processing system to process the data to detect the discrepancy comprises instructions that cause the processor to:
process data corresponding to transferees and transferors within the chain-of-title to determine a break in the chain, wherein the break indicates the discrepancy.

3. The computer readable storage medium of claim 2, further comprising instructions that, when executed by the processing system, cause the processing system to:
determine if the break in the chain-of-title involves an error associated with a serial number of the asset; and
identify a second asset to which an ownership document, which caused the break and which incorrectly includes the serial number of the asset, should refer.

4. The computer readable storage medium of claim 3, wherein the instructions that, when executed by the processing system, cause the processing system to generate the output further comprise instructions that, when executed, cause the processing system to:
generate a first output comprising an alert communicating the discrepancy to a user account associated with the asset; and
selectively generate a second output to alert an intended owner of the second asset to the discrepancy.

5. The computer readable storage medium of claim 1, wherein the instructions that, when executed, cause the processing system to receive the data further comprise instructions that cause the processing system to:
retrieve an ownership record from the data source;
extract ownership data from the ownership record; and
retrieve second data associated with the asset from a second data source.

6. The computer readable storage medium of claim 5, wherein the instructions that, when executed, cause the processing system to process the data further comprise instructions that cause the processing system to:
compare the ownership data from the ownership record to the second data to detect the discrepancy.

7. The computer readable storage medium of claim 1, wherein the asset comprises at least one of an issued patent, a published patent application, a trademark application, a registered trademark, and a copyright.

8. The computer readable storage medium of claim 1, wherein the asset comprises at least one of a secured asset, a financial instrument, and an insurance transaction.

9. A method comprising:
receiving data at an input of a computing system, the data including a chain-of-title corresponding to an asset;
automatically detecting a discrepancy in the chain-of-title of the asset in response to receiving the data; and
generating an output in response to detecting the discrepancy.

10. The method of claim 9, wherein the asset comprises an intellectual property asset; and
wherein receiving the data comprises retrieving inventor data from at least one data source and retrieving ownership data from at least one second data source.

11. The method of claim 10, wherein automatically detecting the discrepancy in the chain-of-title comprises:
automatically tracing transferors to transferees through the chain-of-title to detect the discrepancy when transfers from the transferors to the transferees do not provide a linear chain.

12. The method of claim 10, the method further comprising:
determining that the discrepancy comprises an error if the inventor data does not substantially match assignor data determined from the assignment data; and
determining that the discrepancy comprises a fraud if the assignment data indicates that the inventor assigned the asset to more than one assignee through different conveyances.

13. The method of claim 10, wherein automatically detecting the discrepancy comprises:
identifying a break in the chain-of-title of the asset;
extracting the identifier, names of one or more transferors, and names of one or more transferees associated with the break in the chain-of-title; and
searching at least one data source using variations of a first document number associated with the asset and using the names of the one or more transferors and the names of the one or more transferees to identify a second asset having a second document number that differs from the first document number by at least one character and that includes at least one of the names of the one or more transferees.

14. The method of claim 13, wherein generating the output comprises:
generating a first output to communicate data related to the discrepancy to an owner of the asset; and
generating a second output addressed to an intended owner of the second asset.

15. The method of claim 9, wherein the asset comprises intellectual property, the intellectual property comprising at least one of a patent, a published patent application, a trademark application, a trademark registration, and a copyright.

16. A system comprising:
an interface adapted to receive data including information corresponding to a chain-of-title of an asset;
a processing system configured to receive the data from the interface; and
one or more memory accessible to the processing system and configured to store a plurality of instructions that, when executed by the processing system, cause the processing system to identify a discrepancy in the chain-of-title of the asset in response to receiving the data and to generate at least one output including data related to the discrepancy.

17. The system of claim 16, wherein the plurality of instructions further comprises instructions that, when executed by the processing system, cause the processing system to:
identify a second asset corresponding to the discrepancy in the chain-of-title;
generate a first output addressed to an owner of the asset and including the data related to the discrepancy; and
selectively generate a second output addressed to an intended owner of the second asset and including the data related to the discrepancy.

18. The system of claim 16, wherein the plurality of instructions that, when executed, cause the processing system to identify the discrepancy comprises instructions that, when executed, cause the processing system to:
trace the chain-of-title to identify a break in the chain; and
generate the at least one output including data identifying the break in the chain-of-title.

19. The system of claim 16, wherein the plurality of instructions that, when executed, cause the processing system to identify the discrepancy comprises instructions that, when executed, cause the processing system to:
retrieve data related to the asset from a data source;
compare the data from the asset to data from the chain-of-title to detect the discrepancy;
generate the at least one output indicating an error if a first owner in the chain-of-title does not substantially match the data related to the asset; and
generate the at least one output indicating a fraud if the chain-of-title includes more than one conveyance from a conveying entity to different receiving entities.

20. The system of claim 16, wherein the plurality of instructions further comprises instructions that, when executed by the processing system, cause the processing system to:
automatically generate one or more documents including data related to the discrepancy, the one or more documents for submission to a recording agency to correct the discrepancy.

21. The system of claim 16, wherein the plurality of instructions further comprises instructions that, when executed by the processing system, cause the processing system to:
receive schedule data indicating a periodic interval; and
receive the data and identify the discrepancy periodically according to the schedule data.

22. A system comprising:
an interface configurable to couple to a network and adapted to receive discrepancy data corresponding to a discrepancy in a chain-of-title of an asset from a discrepancy detection system;
a processing system configured to receive the discrepancy data from the interface; and
one or more memory accessible to the processing system and configured to store subscriber preferences and a plurality of instructions that, when executed by the processing system, cause the processing system to:
retrieve a notification preference of a subscriber associated with the asset from the subscriber preferences in response to receiving the data;
generate at least one output including data related to the discrepancy based on the notification preference of the subscriber; and
transmit the at least one output to a corresponding at least one device associated with the subscriber.

23. The system of claim 22, wherein the one or more memory includes a second plurality of instructions that, when executed by the processing system, cause the processing system to:
provide a user interface accessible to the subscriber to provide information about one or more assets to be monitored including the asset;
send a query identifying the asset to the discrepancy detection system; and
receive the discrepancy data corresponding to the discrepancy in the chain-of-title of the asset from the discrepancy detection system in response to sending the query.

24. The system of claim 23, wherein the user interface includes at least one selectable element accessible to the subscriber to schedule sending of the query.

25. The system of claim 22, wherein the one or more memory includes a second plurality of instructions that, when executed by the processing system, cause the processing system to:
provide a user interface accessible to the subscriber to provide information about one or more assets to be monitored, the information about the one or more assets including information about the asset;
periodically communicate data related to each of the assets to the discrepancy detection system to monitor an ownership state of each of the one or more assets; and
selectively transmit a notice to a subscriber based on the subscriber preferences when a signal is received from the discrepancy detection system indicating that the chain-of-title of the asset has a discrepancy.

26. A system comprising:
a processor for producing a graphical user interface including an input for receiving investigative information from a user to define an investigation, the investigative information including at least one of a name of a company, a name of an individual, and a list of asset identifiers, the graphical user interface for providing an alert in response to receiving the investigative information; and
an output coupled to the processor for providing the alert to the user.

27. The system of claim 26, wherein:
the output comprises a display; and
the alert comprising at least one of text information and graphical information related to the investigation.

28. The system of claim 26, wherein the output comprises a signal sent to at least one of a cell phone and a computer.

29. The system of claim 26, wherein the alert indicates data indicating a discrepancy in a chain of title of at least one asset associated with one of the company, the individual, and the list of asset identifiers.

30. The system of claim 29, wherein:
the graphical user interface includes data related to one or more assets, each of the one or more assets having an associated discrepancy; and the graphical user interface includes at least one user-selectable option for resolving the associated discrepancy associated with at least one of the one or more assets.

31. The system of claim 30, wherein the at least one user-selectable option includes a first option to fix the associated discrepancy and a second option to ignore the associated discrepancy.
